(19) United States
(12) Patent Application Publication
(10) Pub. No.: US 2011/0127252 A1
(43) Pub. Date: Jun. 2, 2011

(54) HEATING DEVICE HAVING A FUNCTION OF DYNAMICAL TEMPERATURE-CONTROL

(75) Inventors: MING-HUI YU, TAIPEI CITY (TW); A-TZU CHEN, TAIPEI COUNTY (TW); CHIA-JUNG KAO, TAIPEI CITY (TW); WANG-TSUNG LIANG, TAOYUAN COUNTY (TW)

(73) Assignee: TANGTECK EQUIPMENT INC., TAOYUAN COUNTY (TW)

(21) Appl. No.: 12/954,690

(22) Filed: Nov. 26, 2010

(30) Foreign Application Priority Data
Nov. 27, 2009 (TW) 98222290
Feb. 10, 2010 (TW) 99202853

(51) Int. Cl. A21B 1/00

(52) U.S. Cl. 219/408; 219/391

(57) ABSTRACT

A heating device with a function of dynamical temperature-control includes an oven housing, a door, at least one air-discharge device and a plurality of heaters. The oven housing has a plurality of walls, and the walls define a chamber. The door is pivoted disposed on the oven housing. The air-discharge device and the heaters are disposed on the oven housing. The heaters are respectively dynamical-adjustable and independent-operating heating elements to achieve the uniformity of chamber temperature.

### BACKGROUND OF THE INVENTION

1. Field of the Invention

The present invention is a heating device; especially, the present invention relates to a heating device having a function of dynamical temperature-control.

2. Description of Related Art

Heating devices, such as ovens are common used for heating objects in industry or for heating foods. Traditional heating device has a main body and a door. The main body is constructed by walls which define a chamber. The main body has an entrance and the door is pivoted on the main body for opening or closing the entrance. Heaters such as electric bars or electric heating filaments generate heat for increasing the chamber temperature so as to heat the objects or foods.

However, the traditional heaters on the heating device are controlled together. The heating power is adjusted by changing the positions of the heaters or changing the amount of the heater. On the other hand, after assembling the heaters on the main body, the power of the heaters cannot be adjusted. As a result, the chamber temperature is not uniform. User has to change the heater in order to adjust the heating power; therefore the cost and time are increased.

Consequently, with regard to the resolution of defects illustrated hereinbefore, the inventors of the present invention propose a reasonably and effectively designed solution for effectively eliminating such defects.

### SUMMARY OF THE INVENTION

One objective of the present invention is to provide a heating device with a function of dynamical temperature-control. The heating chamber of the heating device has uniform temperature distribution thereof.

Another objective of the present invention is to provide a heating device with a function of dynamical temperature-control which can supply for superheated steam and protective gas simultaneously. The heating device can be used for cooking foods efficiently and healthily.

The present invention discloses a heating device with a function of dynamical temperature-control, comprising: an oven housing having a plurality of walls, the walls defining a chamber; a door, disposed on the oven housing; at least one air-discharge device, disposed on the oven housing; and a plurality of heaters, disposed on the oven housing, wherein the heaters are dynamical-adjustable and independent-operating heating elements.

The present invention further discloses a heating device with a function of dynamical temperature-control, comprising: an oven housing having a plurality of walls, the walls defining a chamber; a door, disposed on the oven housing; at least one air-discharge device, disposed on the oven housing or on the door; and a plurality of heaters, disposed on the door, wherein the heaters are respectively dynamical-adjustable and independent-operating heating elements.

The present invention further discloses a heating device with a function of dynamical temperature-control, comprising: an oven housing having a plurality of walls, the walls defining a chamber; a door, disposed on the oven housing; and a plurality of heaters, disposed on the selected walls, wherein each of the heaters has several independent-operating heating units.

The heating device of the present invention has heaters disposed on the walls or on the door. The heaters are independent-operating and have independent-adjustable heating elements. In other words, the heaters can be dynamically adjusted by electrical controlling method so that users and manufacturers can modify the power distribution of the heaters to achieve the uniformity of chamber temperature.

The heating device of the present invention has an air-discharge device for gas circulating in the chamber so that the effects of uniform temperature and uniform distribution of gas are achieved.

The first supplying device is providing for superheated steam which can be applied to heat objects, save the usage of the protective gas, and to react with the object component or decompose the object. On the other hand, the second supplying device is providing for protective gas to decrease the concentration of oxygen, to reduce the oxidation and to reduce the oil degradation.

In order to further appreciate the characteristics and technical contents of the present invention, references are hereunder made to the detailed descriptions and appended drawings in connection with the present invention.

However, the appended drawings are merely shown for exemplary purposes, rather than being used to restrict the scope of the present invention.

### BRIEF DESCRIPTION OF THE DRAWINGS

FIG. 1 is a front view of the heating device of the first embodiment according to the present invention (without door);

FIG. 2 is a side view of the heating device of the first embodiment according to the present invention;

FIG. 3 is functional blocks of the heaters of the first embodiment according to the present invention;

FIG. 4 is structural diagram of the heating device of the second embodiment according to the present invention;

FIG. 5 is a front view of the heating device of the second embodiment according to the present invention (without door);

FIG. 6 is a side view of the heating device of the second embodiment according to the present invention;

FIG. 7 is a rear view of the door of the third embodiment according to the present invention;

FIG. 8 is functional blocks of the heating units of the heaters of the third embodiment according to the present invention;

FIG. 9 is a front view of the heating device of the fourth embodiment according to the present invention;

FIG. 10 is a front view of the heating device of the fifth embodiment according to the present invention.

### DETAILED DESCRIPTION OF THE PREFERRED EMBODIMENTS

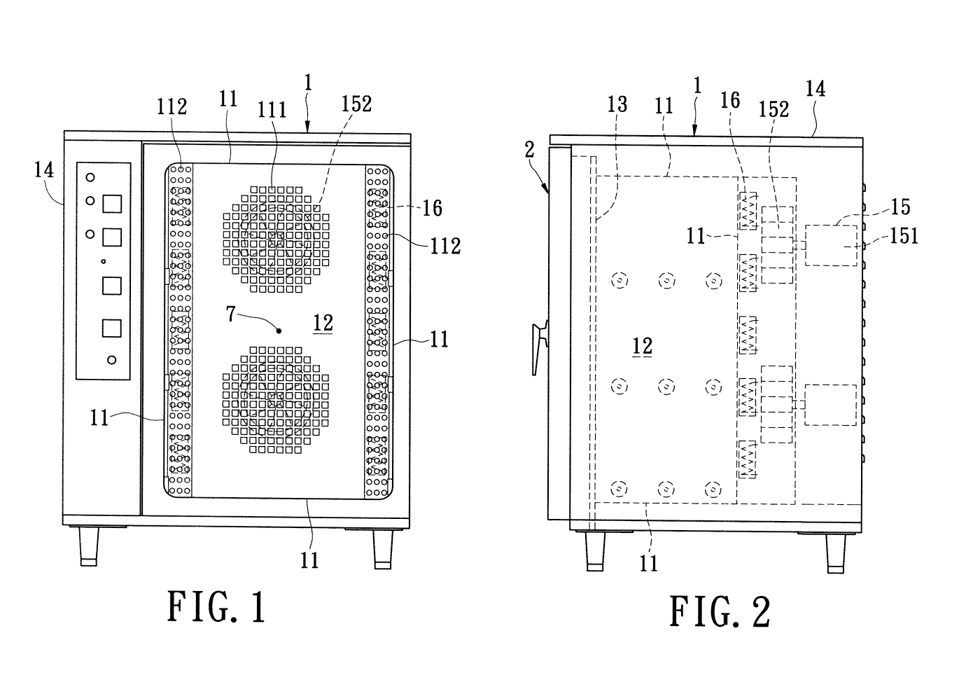

Please refer to FIGS. 1 and 2; a heating device with a function of dynamical temperature-control is provided. The heating device has a dynamical temperature-control device for dynamically controlling the power distribution of the heating device. The dynamical temperature-control device can be applied for various heating device. For exemplary describing, the dynamical temperature-control device is used in a box-type heating device.

In the exemplary embodiment, the heating device includes an oven housing 1 and a door 2. The oven housing 1 is a cube-shaped housing and made of stainless steel, and the walls 11 can has fire retarding and thermal insulating material for thermal insulation. The oven housing 1 has five walls 11, i.e., bottom wall, top wall, left wall, right wall, and rear wall. The walls 11 define a chamber 12 for accommodating objects. The front side of the oven housing 1 has an oven opening 13 for loading/unloading the objects. The walls 11 have metal casing(s) 14 covering the outer surfaces thereof Alternatively, the oven housing 1 can be a cylindrical housing, or the oven housing 1 can have six (6) or eight (8) walls 11.

The rear wall 11 of the oven housing 1 has first openings 111, second openings 112 and at least one air-discharge device 15. As shown in the figures, the first openings 111 are disposed on the middle areas of the upper and bottom portions of the rear wall 11. The second openings 112 are disposed on the two side areas of the rear wall 11. The first and the second openings 111, 112 are communicated with the chamber 12. The air-discharge device 15 is assembled on the rear wall 11 of the oven housing 1 and communicates between the first openings 111 and the second openings 112. In the exemplary embodiment, the air-discharge device 15 has a motor 151 and fan(s) 152. The oven housing 1 has two air-discharge devices 15 but the type and the number of the air-discharge device 15 is not restricted. The two air-discharge devices 15 respectively correspond to the first openings 111 disposed on the middle areas of the upper and bottom portions of the rear wall 11. Therefore, the gas flows from the chamber 12 of the oven housing 1 through the first openings 111, the air-discharge devices 15 and the second openings 112 to back into the chamber 12 so that the gas is circulating in the chamber for uniform temperature.

The oven housing 1 has a plurality of heaters 16 which are corresponding to the second openings 112. The heaters 16 are respectively independent-operating heating elements, for example, electric bars or electric heating filaments. In the example, the heaters 16 are spaced on the rear wall 11 of the housing 1. The heaters 16 are disposed inside the rear wall 11 and are in front of the air-discharge devices 15. However, the position and the arrangement of the heaters 16 are not restricted.

Alternatively, the first and the second openings 111, 112, the air-discharge devices 15 and the heaters 16 can be positioned on another side wall 11. Still alternatively, the first and the second openings 111, 112, the air-discharge devices 15 and the heaters 16 can be disposed on the door 2. In other words, the door 2 has first and the second openings 111, 112 thereon (not shown) and the first and the second openings 111, 112 are communicated with the chamber 12. The air-discharge device 15 communicates between the first openings 111 and the second openings 112 and the heaters 16 are disposed on the door 2 correspondingly to the second openings 112.

The gas in the chamber 12 is circulated inside the chamber 12 by the two air-discharges device 15 and further the gas can be heated while passing through the heaters 16. The heated gas is provided for controlling the temperature of the chamber 12 so as to heat the object(s) in the oven housing 1.

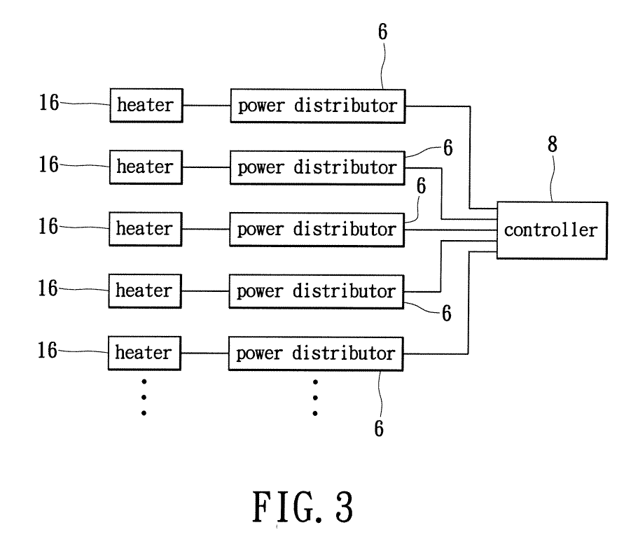

In addition, each of the heaters 16 is electrically connected to a power distributor 6, as shown in FIG. 3. The heaters 16 further have temperature-controlling point 7, for example, many heaters 16 can be controlled by one temperature-controlling point 7. Moreover, the power distributors 6 are electrically connected to a controller 8. Therefore, the output power of the heaters 16 can be dynamically controlled by an electrical control method. In other words, the heaters 16 are dynamical-adjustable elements.

The door 2 is pivotedly assembled with the oven housing 1. In the exemplary embodiment, the door 2 is a square-shaped door and the door 2 can have single-layer structure or multi-layer structure. The shape of the door 2 corresponds to the shape of the oven opening 13, but not restricted thereby. The door 2 is used to open/close the oven opening 13.

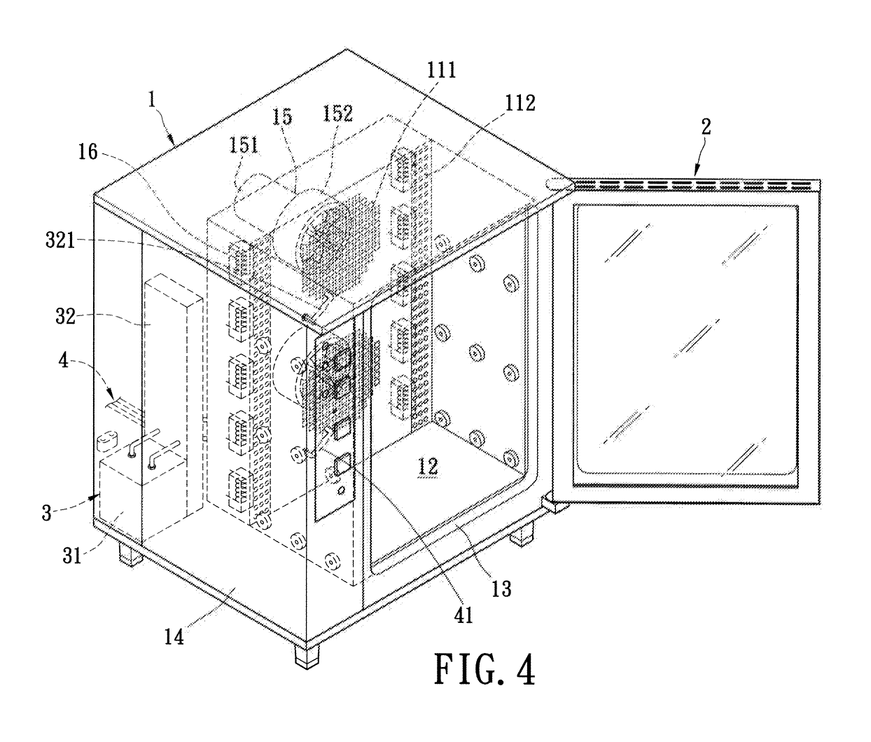

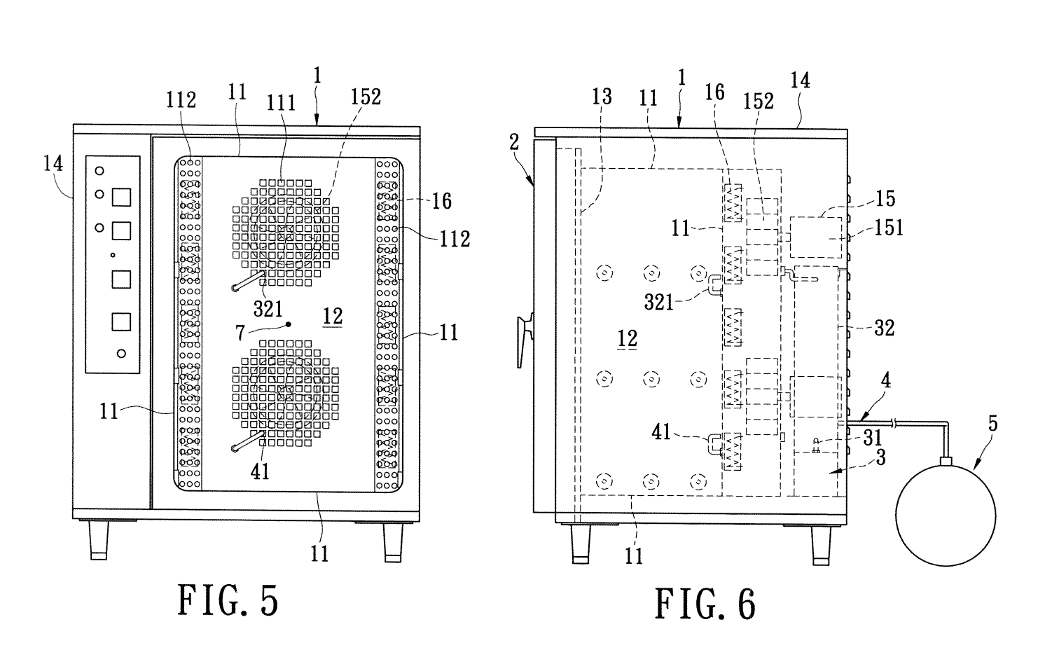

Please refer to FIGS. 4 to 6; another exemplary embodiment is shown and the heating device further has a first supplying device 3 for superheated steam supply and a second supplying device 4 for protective gas supply (e.g., nitrogen). The first supplying device 3 is providing for superheated steam and the second supplying device 4 is providing for protective gas. The superheated steam and the protective gas flow from the chamber 12 of the oven housing 1 through the first openings 111, the air-discharge devices 15 and the second openings 112 back into the chamber 12 so that the superheated steam and the protective gas are circulating in the chamber 12 for uniform temperature and uniform distribution of gas.

The first supplying device 3 connects to the oven housing 1 for providing superheated steam into the chamber 12. The first supplying device 3 has a steam generator 31 and an auxiliary heater 32. The steam generator 31 and the auxiliary heater 32 have a connection pipe therebetween, and a water/liquid supply is connected to the steam generator 31 for supplying water/liquid into the steam generator 31. Therefore, the steam generator 31 can heat the water/liquid to the boiling temperature to generate dry and saturated steam. Then, the dry and saturated steam can be heated to higher temperature, for example 300E, by the auxiliary heater 32 for forming the superheated steam. The auxiliary heater 32 is connected to the oven housing 1 via a pipe 321. One end of the pipe 321 is located near the first openings 111 or is located between the first openings 111 and the second openings 112. Therefore, the superheated steam supplied by the first supplying device 3 flows from the chamber 12 of the oven housing 1 through the first openings 111, the air-discharge devices 15 and the second openings 112 back into the chamber 12 so that the superheated steam is efficiently circulating in the chamber 12.

The second supplying device 4 connects to the oven housing 1 and has supplying pipe 41 for supplying protective gas such as nitrogen into the chamber 12. In the exemplary embodiment, the second supplying device 4 is directly connected with the oven housing 1 so that the protective gas is directly supplied into the chamber 12 without heating the protective gas. In an alternatively example, one end of the supplying pipe 41 is connected to the auxiliary heater 32 and then to the oven housing 1; therefore, the protective gas is heated by the auxiliary heater 32 and then is supplied into the chamber 12 through the pipe. One end of the supplying pipe 41 is located near the first openings 111 or is located between the first openings 111 and the second openings 112. Therefore, the protective gas flows from the chamber 12 of the oven housing 1 through the first openings 111, the air-discharge devices 15 and the second openings 112 back into the chamber 12 so that the protective gas is efficiently circulating in the chamber 12. Accordingly, the steam or gas in the chamber 12 can be circulated by the air-pumping function of the air-discharge devices 15, and can be heated by the heater 16 or the auxiliary heater 32 so as to increase the temperature of the chamber 12 for heating the objects inside the chamber 12.

The heating device can be used for heating foods. A gas supply unit 5 can be connected to the supplying pipe 41. There can be a dish disposed inside the chamber 12 for heating the fried or baked foods. Oil can be sprayed on the foods or the foods can be dipped into the oil before the heating procedure. Whiling heating the foods, the superheated steam can be supplied into the chamber 12 by the first supplying device 3.

The heating device also can be used in industry applications. For example, industry metal, metal powders, metal oxide, metal carbide, or metal nitride can be heated by the heating device of the present invention. While heating the industry objects, the protective gas (i.e., nitrogen) is applied into the chamber 12 for preventing the industry objects form oxidization.

The air-discharge device 15 is provided for gas circulating in the chamber 12 so that the effects of uniform temperature and uniform distribution of gas are achieved. On the other hand, dynamical-adjustable and independent-operating heaters 16 are disposed on the second openings 112 of the oven housing 1 (or on the door 2); therefore, users and manufacturers can modify the power distribution of the heaters 16 dynamically by the electric controlling method. As a result, the temperature of the chamber 12 is more uniform for heating object.

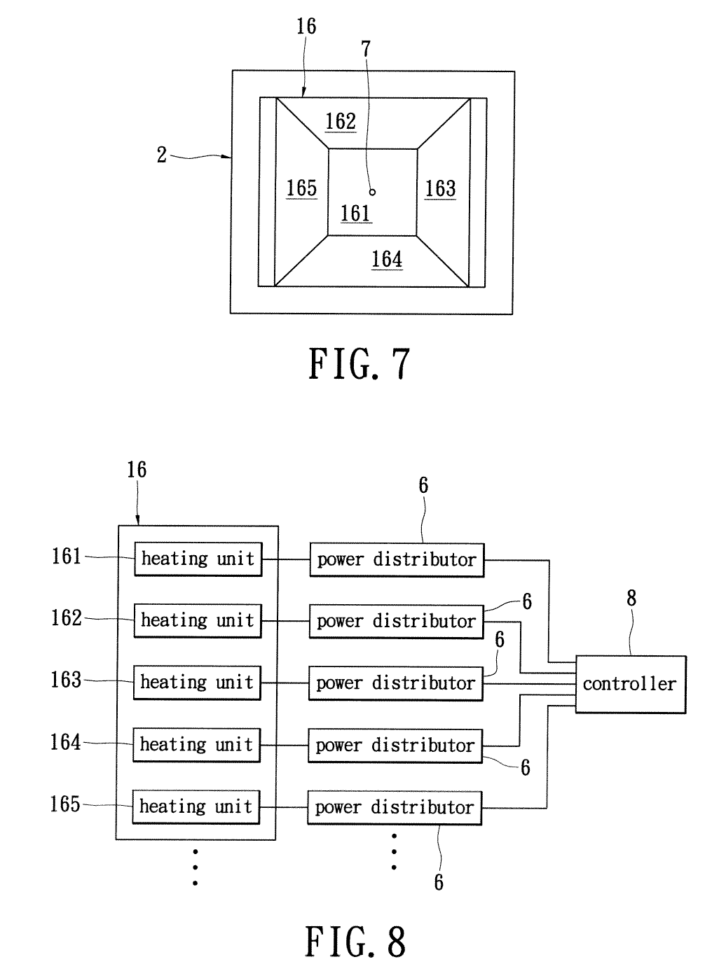

Please refer to FIGS. 7 and 8; the heaters 16 can be disposed on the selected walls 11. For example, the heaters 16 can be disposed on the four walls 11 (i.e., top wall, bottom wall, left wall and right wall), or on five walls 11 (i.e., top wall, bottom wall, left wall right wall and rear wall) and door 2. In other words, the heaters 16 can be disposed on partial of or all of the walls 11. FIG. 7 shows the heaters 16 arranged on the door 2. Each of the heaters 16 disposed on the walls 11 or on the door 2 has independent-operating heating units 161,162,163,164,165. In the embodiment, one of the heating units (i.e., heat unit 161) is located at a central position and the remaining heating units (i.e., heat units 162,163,164,165) surround the central heating unit 161, but not restricted thereby.

Each of the heating units 161,162,163,164,165 is electrically connected to a power distributor 6, as shown in FIG. 8 and the heating units 161,162,163,164,165 of each heater 16 have one common temperature-controlling point 7. In the embodiment, the temperature-controlling point 7 is located at the central heating unit 161 for reducing the usage of the temperature-controlling point 7. Furthermore, the power distributors 6 are electrically connected to a controller 8 so as to modify the power distribution of the heating units 161,162,163,164,165 dynamically by the electric controlling method.

The heater 16 on each wall 11 or door 2 has a plurality of dynamical-adjustable and independent-operating heating units, and users and manufacturers can modify the power distribution of the heating units dynamically by the electric controlling method. As a result, the temperature of the chamber 12 is more uniform for heating object.

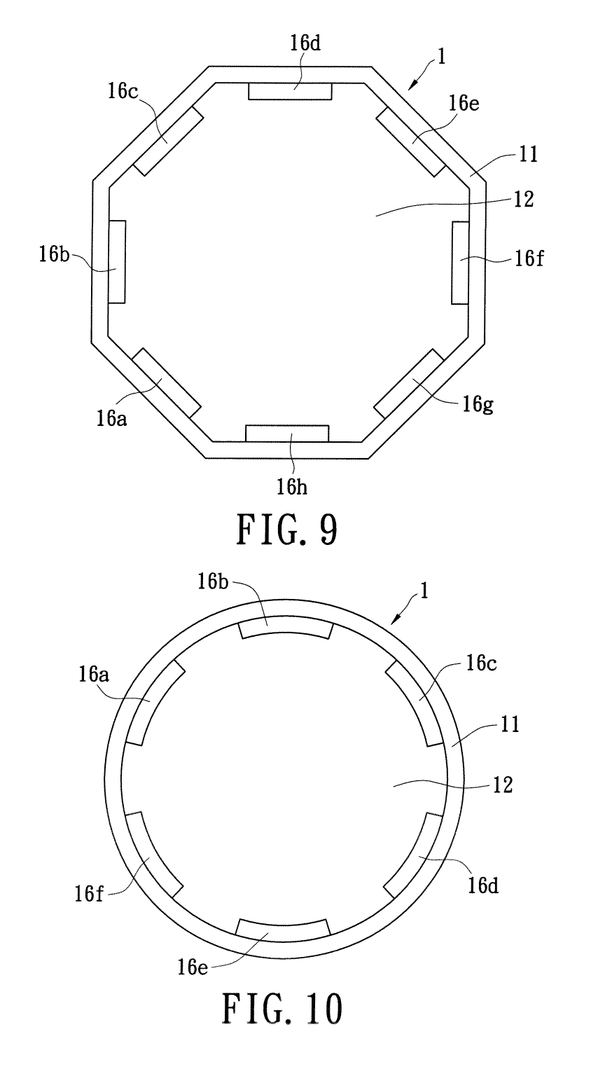

Please refer to FIG. 9; the heating device has an oven housing 1 and a plurality of heaters 16a,16b,16c,16d,16e,16f,16g and 16h. The oven housing 1 has at least one wall 11, for example, eight walls 11, which define a chamber 12. The heaters 16a to 16h are dynamical-adjustable and independent-operating heating elements. Alternatively, the heaters can be grouped as different groups. For example, the heaters 16a to 16d are grouped and they can be adjusted and controlled together. The heaters 16e to 16h are grouped as another group and the heaters in the same group are adjusted and controlled together.

Please refer to FIG. 10; the heating device has an oven housing 1 and a plurality of heaters 16a,16b,16c,16d,16e, and 16f. The oven housing 1 has one wall 11 which define a chamber 12. The heaters 16a to 16f are dynamical-adjustable and independent-operating heating elements. Alternatively, the heaters can be grouped as different groups. For example, the heaters 16a to 16c are grouped and they can be adjusted and controlled together. The heaters 16d to 16f are grouped as another group and the heaters in the same group are adjusted and controlled together.

What is claimed is:

1. A heating device with a function of dynamical temperature-control, comprising:
an oven housing having a plurality of walls, the walls defining a chamber;
a door, disposed on the oven housing;
at least one air-discharge device, disposed on the oven housing; and
a plurality of heaters, disposed on the oven housing, wherein the heaters are dynamical-adjustable and independent-operating heating elements.

2. The heating device according to claim 1, wherein each of the heaters is electrically connected to a power distributor, and the power distributors are electrically connected to a controller.

3. The heating device according to claim 1, wherein the heaters have a temperature-controlling point.

4. The heating device according to claim 1, wherein the walls have first openings and second openings, the first openings and the second openings are communicating with the chamber, and the air-discharge device communicates between the first openings and the second openings.

5. The heating device according to claim 4, wherein the heaters are located on the oven housing correspondingly to the second openings.

6. The heating device according to claim 1, wherein the heaters are spaced on the oven housing.

7. The heating device according to claim 1, further comprising a first supplying device for superheated steam supply and a second supplying device for protective gas supply, wherein the first supplying device connects to the oven housing for supplying superheated steam into the chamber, and the second supplying device connects to the oven housing for supplying protective gas into the chamber.

8. The heating device according to claim 7, wherein the first supplying device has a steam generator and an auxiliary heater connected with the steam generator, the auxiliary heater is connected to the oven housing via a pipe, the second supplying device has a supplying pipe for supplying nitrogen into the chamber directly or through the auxiliary heater.

9. A heating device with a function of dynamical temperature-control, comprising:
an oven housing having a plurality of walls, the walls defining a chamber;
a door, disposed on the oven housing;
at least one air-discharge device, disposed on the oven housing or on the door; and
a plurality of heaters, disposed on the door, wherein the heaters are respectively dynamical-adjustable and independent-operating heating elements.

10. The heating device according to claim 9, wherein each of the heaters is electrically connected to a power distributor, and the power distributors are electrically connected to a controller.

11. The heating device according to claim 9, wherein the heaters have a temperature-controlling point.

12. The heating device according to claim 9, wherein the door has first openings and second openings, the first openings and the second openings are communicating with the chamber, the air-discharge device communicates between the first openings and the second openings, and the heaters are located on the door correspondingly to the second openings.

13. The heating device according to claim 9, further comprising a first supplying device for superheated steam supply and a second supplying device for protective gas supply, wherein the first supplying device connects to the oven housing for supplying superheated steam into the chamber, and the second supplying device connects to the oven housing for supplying protective gas into the chamber.

14. A heating device with a function of dynamical temperature-control, comprising:
an oven housing having a plurality of walls, the walls defining a chamber;
a door, disposed on the oven housing; and
a plurality of heaters, disposed on the selected walls, wherein each of the heaters has independent-operating heating units.

15. The heating device according to claim 14, wherein one of the heating units is located at a central position and the remaining heating units surround the central heating unit.

16. The heating device according to claim 14, wherein the heating units of each heater have a temperature-controlling point.

17. The heating device according to claim 14, wherein the heaters are disposed on all of the walls.

18. The heating device according to claim 14, wherein the heaters are disposed on the door and all of the walls.

19. The heating device according to claim 14, wherein the oven housing is a cube-shaped housing or a cylindrical housing, the oven housing has five, six or eight walls, and the walls have metal casing covering an outer surfaces thereof.

20. The heating device according to claim 14, wherein each of the heating units is electrically connected to a power distributor.

21. The heating device according to claim 20, wherein the power distributor is electrically connected to a controller.

22. A heating device with a function of dynamical temperature-control, comprising:
an oven housing having a plurality of walls, the walls defining a chamber; and
a plurality of heaters, disposed on the oven housing, wherein the heaters are respectively dynamical-adjustable and independent-operating heating elements.
